(19) United States
(12) Patent Application Publication
(10) Pub. No.: US 2008/0271377 A1
(43) Pub. Date: Nov. 6, 2008

(54) Combination Metal-Based and Hydride-Based Hydrogen Sources and Processes for Producing Hydrogen

(75) Inventor: Yu Zhou, Dublin, CA (US)

Correspondence Address: MORRISON & FOERSTER LLP, 755 PAGE MILL RD, PALO ALTO, CA, 94304-1018, US

(73) Assignee: H2VOLT, INC., Hayward, CA (US)

(21) Appl. No.: 11/630,056

(22) PCT Filed: Jun. 17, 2005
(86) PCT No.: PCT/US05/21620

§ 371 Date: Apr. 29, 2008

Related U.S. Application Data
(60) Provisional application No. 60/580,801, filed on Jun. 18, 2004.

(51) Int. Cl. C01B 3/10

(52) U.S. Cl. 48/197 FM; 252/188.25

(57) ABSTRACT

A metal based hydrogen source contains metal such as Al, Zn, Mg that can react with water to produce hydrogen gas, borohydride such as sodium borohydride, potassium borohydride etc, and hydroxides such as NaOH and KOH etc. The hydrogen generation follows the following processes: First, metal aluminum reacts with water and hydroxide to produce hydrogen gas an heat, at the same time, hydroxide, the stabilizer of sodium borohydride, is consumed; As sodium borohydride is de-stabilized by the consuming of sodium hydroxide, hydrogen gas is produced through hydrolysis reaction of borohydride. The hydrolysis reaction can be accelerated by utilizing the heat that comes from aluminum's reaction with water. At the same time, hydroxides are partly or completely eliminated from the byproduct. The hydrogen gas produced may be used for any purpose.

### FIELD

Described here are combination metal-based and hydride-based hydrogen sources and methods of producing hydrogen gas using those sources.

### BACKGROUND

Many fuel cell power generators are systems made up of two major parts: a fuel cell and a hydrogen source.

The fuel cell was invented some 150 years ago. Its performance has been improved during the past one and half centuries. Fuel cells of high quality are available from a variety of fuel cell companies located in different parts of the world. Any of the available fuel cells run very well so long as the source hydrogen is continuously supplied.

Hydrogen sources include three major commercial types: hydrogen generation, hydrogen storage, and hydrogen delivery. In concept, though, hydrogen delivery is simply the delivery of stored hydrogen. Consequently, only hydrogen generation and hydrogen storage are truly independent sources.

There are many mature ways of generating hydrogen. However, there are no practical ways of storing large volumes of hydrogen once the criteria of capacity, safety, and refueling are considered. For instance, hydrogen-containing vessels, whether they are high pressure gas-containing cylinders or liquid-containing vessels, have significant and lingering safety problems. The alloys are used as hydrogen sinks, e.g., metal hydrides, have limited capacity and are inconvenient for replenishing. The reforming of fossil fuels or other hydrogen-carbon compounds to produce hydrogen not only requires complex equipment, but often produces carbon dioxide as a byproduct. That co-production of carbon dioxide makes the goal of using a hydrogen-oxygen fuel cell to reduce or to eliminate carbon dioxide emission a useless goal. Some so-called new technologies, such as hydrogen storage nano-carbon, bio-hydrogen, etc., are likely decades away from practical applications.

Certain metals, such as aluminum, readily react with water in alkaline solution to produce hydrogen gas. However, 1 mol of aluminum metal produces but 1.3 grams of hydrogen gas. This is not a sufficient amount in some applications.

U.S. Pat. Nos. 5,804,329, to Amendola, and 6,706,909, to Snover et al, describe technologies to produce hydrogen gas from sodium borohydride. However, these technologies utilize precious metal catalysts. The hydroxides that are used as stabilizers of the sodium borohydride reactant do not react and are left as a byproduct once the hydrogen production has ceased. Also, processes using only sodium borohydride to produce hydrogen are quite expensive.

The procedures shown in the Amendola and Snover et al patents discussed just above, to produce hydrogen gas use the following steps:

the sodium borohydride reactant is stabilized by a hydroxide ion, a standard method developed several decades ago for stabilizing, storing, and transporting sodium borohydride; and

the stabilized sodium borohydride is then contacted with a precious metal catalyst to generate hydrogen via a hydrolysis reaction.

The reaction product, in addition to the hydrogen, is NaBO₂. The stabilizer sodium hydroxide still remains as a byproduct.

There are two economic demerits for this process: the first is that the byproduct contains a lot of hydroxide, which makes recycling the byproduct difficult; and the second is that expensive precious metal catalysts are used.

As mentioned above, another route for producing hydrogen gas is via the reaction of certain metals, such as metallic aluminum, with basic aqueous solutions. The chemical base may be sodium hydroxide. This reaction doesn't need a catalyst and the byproducts may be tailored to result in but a few hydroxides. However, the capacity of hydrogen generation limits its application.

### SUMMARY

Described here is a combination metal-based and hydride-based composition as a hydrogen source. The source often has a high hydrogen capacity and high energy density. The hydrogen source may use a low cost hydrogen-producing metal such as aluminum to complement, to partly replace, or to completely replace expensive metal hydrides or other hydrogen-containing or hydrogen-generating materials.

The process for using the metal-based hydrogen source, particularly when including a metal borohydride, produces hydrogen gas with or without using catalysts, such as precious metal catalysts. The process typically does not include metal hydroxides as byproducts.

### BRIEF DESCRIPTION OF THE DRAWINGS

FIG. 1 shows the comparison of specific energy density of various widely used energy sources with one variation of our described hydrogen source.

### DETAILED DESCRIPTION

In general, described here are compositions useful for generating hydrogen and procedures for generating hydrogen using the compositions.

### Compositions

The hydrogen-generating composition may be made up of the following components:

one or more hydrogen-generating hydrides, such as: one or more metal, semi-metal, or ammonium hydrides (or mixtures of those metal, semi-metal, or ammonium hydrides) that react with water to produce hydrogen,

one or more hydrogen-generating metal sources, such as: one or more pure metals, mixed metals, or alloys that react with a chemical base to produce hydrogen, and

a chemical base that both, i) stabilizes the reaction between water and the hydrogen-generating hydride, and ii) reacts with the hydrogen-generating metal source in an aqueous reaction media to produce hydrogen.

The composition may comprise the components in isolation or in admixture as set out below. The hydrogen-generating hydride components, hydrogen-generating metal source components, and the chemical base components of the composition may be in solid form, e.g., one or more porous solids, a block solid, a granular form, powder, or coated upon or included within an inert or other solid structure. The components may be situated in a form that is integral, e.g., the hydrogen-generating hydride components and the hydrogen-generating metal source components may be formed into a solid mass, perhaps with an amount of porosity to allow passage of basic-pH water or (if the basic stabilizer is suitably solid and integrated into such a solid mass) to allow passage of water or other aqueous solutions as an initiator of the hydrogen-producing reactions.

In sum, the described composition may have one or more components substantially isolated from the others and yet remain a component of the composition. This is due, in general, to the chemical interaction of the components. One desirable reaction pathway is the sequential reaction of, for instance, the hydrogen-producing metallic source in the presence of the chemical base thereby allowing the subsequent reaction of water with the then-destabilized hydrogen-producing hydride. Separating the components to achieve such results may be appropriate.

Additionally, for some variations of the composition, as permitted by the nature of the hydrides, the hydrogen-producing hydrides and their complementary chemical base stabilizer may comprise an aqueous solution.

The described composition may specifically comprise the following:

the hydrogen-generating hydrides and chemical base components are admixed, and the hydrogen-generating metal components are isolated from the hydrogen-generating hydride and chemical base components;

the hydrogen-generating hydrides, chemical base components, and the hydrogen-generating metal components are admixed, and

the hydrogen-generating hydrides, chemical base components, and the hydrogen-generating metal components are each isolated from one another.

As should be apparent, each of the listed variations reacts in a different way to produce hydrogen. In composition A), for instance where the composition is dry, water might be introduced to the admixture of hydrogen-generating hydrides and chemical base components to allow dissolution of the chemical base components, to allow reaction of the hydrogen-generating hydrides to form hydrogen. The resultant basic solution would then be passed to the isolated hydrogen-generating metal components to produce additional hydrogen.

The composition may further comprise water in one or more of the variations listed above. The water may be included in one or more of the various isolated or integrated portions.

### Metals

The one or more hydrogen-generating metal sources, e.g., one or more pure metals, mixed metals, or alloys that react with a chemical base to produce hydrogen, generally include aluminum, magnesium, and zinc but lithium, sodium, potassium, rubidium are also suitable.

### Hydrides

The hydrogen-generating hydride components may comprise one or more metal, semi-metal, or ammonium hydrides, perhaps having the general chemical formula MBH₄ where:
M is one or more of an alkali metal (lithium, sodium, potassium, rubidium, and cesium) and an alkaline earth metal (beryllium, magnesium, calcium, strontium, and barium). M may also be an ammonium or organic group.
B is selected from boron, aluminum, and gallium, and
H is hydrogen.

Exempletive metal hydrides include NaBH₄, LiBH₄, KBH₄, Mg(BH₄)₂, Ca(BH₄)₂, NH₄BH₄, (CH₃)₄NH₄BH₄, NaAlH₄, LiAlH₄, KAlH₄, NaGaH₄, LiGaH₄, KGaH₄, and their mixtures. In general, metal hydrides, particularly borohydrides, appear to be more stable in water at basic pH's (i.e., high numerical pH values). The following borohydrides are suitable: sodium borohydride (NaBH₄), lithium borohydride (LiBH₄), potassium borohydride (KBH₄), ammonium borohydride (NH₄BH₄), tetramethyl ammonium borohydride ((CH₃)₄NH₄BH₄), quaternary borohydrides, and their mixtures.

### Stabilizers

Stabilizing agents for hydrogen-producing hydrides should stabilize that component whether admixed in a solution, a dry mixture, or a damp mixture. Aqueous borohydride-containing solutions slowly decompose unless stabilized. The stabilizer or chemical base, as used in this description, is any component that slows, retards, impedes, or prevents the reaction of the hydrogen-producing hydride with water. Typically, an effective stabilizing agent would maintain a hydrogen-producing hydride solution at room temperature (25° C.) at a pH of greater than about 7, greater than about 11, and greater than about 13.

Specifically useful stabilizers include the corresponding hydroxide of the cation part of the hydrogen-producing hydride. For example, if sodium borohydride were to be used as the hydrogen-producing hydride, the corresponding stabilizing agent may be sodium hydroxide. Hydroxide concentrations in the described, stabilized metal hydride solutions may be greater than about 0.1 molar, greater than about 0.5 molar, and greater than about 1 molar or about 4% by weight.

Typically, metal hydride solutions are stabilized by dissolving a hydroxide in water prior to adding the borohydride salt. Examples of suitable hydroxide-based stabilizers include sodium hydroxide, lithium hydroxide, potassium hydroxide, and their mixtures. Sodium hydroxide is especially useful because of its high solubility in water, i.e., up to about 44% by weight. Although other hydroxides are suitable, the solubility differences between various metal hydrides and various hydroxide salts may be taken into account since those solubility differences may be substantial. For example, excess lithium hydroxide addition to a concentrated solution of sodium borohydride would result in precipitation of lithium borohydride.

Other non-hydroxide materials suitable as stabilizing agents or as complements to hydroxide-containing stabilizers include compounds containing lead, tin, cadmium, zinc, gallium, mercury, and their combinations. Various gallium and zinc compounds are stable and soluble in the basic medium and form soluble zincates and gallates, respectively, which are not readily reduced by borohydride.

Compounds containing various non-metals on the right side of the periodic chart are also useful in stabilizing metal hydride solutions. Examples of these non-hydroxide stabilizing agents include compounds containing sulfur, such as sodium sulfide, thiourea, carbon disulfide, and mixtures.

### Catalysts

Although the described compositions may be reacted in such a way that the stabilizers are dissolved and carried away to react with the hydrogen-producing metal component (or simply allowed to react with the hydrogen-producing metal component without being carried away) to produce hydrogen, thereby allowing the hydrogen-producing hydride also to react with water and produce hydrogen, catalysts are not typically needed or desired (because of costs, anyway) for the reaction of the hydride in our described process. However, the presence of a catalyst as an additional (but, optional) component of the described composition or in the practice of the process may provide benefit.

Typically, the catalyst would be chosen to facilitate both the reaction of the metal hydride and water due to the availability of a hydrogen site and to the catalyst's ability to assist in the hydrolysis mechanism, specifically in the reaction with the hydrogen found in water molecules.

Materials that are useful as optional catalysts include transition metals, transition metal borides, and alloys and mixtures of these materials.

Suitable transition metal catalysts are listed in U.S. Pat. No. 5,804,329, to Amendola, e.g., catalysts containing Group IB to Group VIIIB metals, such as transition metals of the copper group, zinc group, scandium group, titanium group, vanadium group, chromium group, manganese group, iron group, cobalt group, and nickel group. Such transition metal elements or compounds catalyze the chemical reaction MBH₄+2H₂O→4H₂+MBO₂ and aid in the hydrolysis of water by adsorbing hydrogen on their surface in the form of atomic H, i.e., hydride H⁻ or protonic hydrogen H⁺. Specific examples of useful transition metal elements include rithenium, iron, cobalt, nickel, copper, manganese, rhodium, rhenium, platinum, palladium, chromium, silver, osmium, iridium, their compounds (particularly, their borides), their alloys, and their mixtures. Ruthenium, cobalt, and rhodium and mixtures may be especially suitable when used with borohydrides.

### Process of Producing Hydrogen

As we have noted above, the compositions outlined there are quite suitable for producing hydrogen in a responsible procedure and with few problematic byproducts.

Many of the hydrogen-producing hydrides, particularly the borohydrides, are stabilized by the hydroxide ion. Indeed, today's standard procedure for maintaining the stability of sodium borohydride solutions is to dissolve sodium borohydride into a hydroxide-containing solution. This relationship between the stability of borohydride and the concentration of hydroxide is the grist of much general chemistry literature.

Since both sodium borohydride and sodium hydroxide are solid materials, in the variation of our composition using those materials, including them as solid materials is useful, since the solid form is much easier to transport and to store than are the corresponding solutions.

In some variations of the composition, the hydrogen-producing metal composition, often aluminum, may be isolated and stored apart from the mixture of borohydride and hydroxide.

When this variation of the composition is provided in the solid form, adding water first to the mixture of borohydride and hydroxide to form a basic solution before passing the alkaline solution to the hydrogen-producing metal based source is desired.

The hydrogen-producing metal based component, aluminum, reacts with water and sodium hydroxide according to the following reactions:

Al+NaOH+H₂O=NaAlO₂+1.5H₂↑+Heat

Or [Al+3H₂O(Alkaline solution)=Al(OH)₃+1.5H₂↑+Heat

Al(OH)₃+NaOH=NaAlO₂+2H₂O+Heat]

During this reaction, the NaOH is consumed by metal aluminum to produce hydrogen gas and heat. The product hydrogen gas may then be used in a fuel cell or other such device.

Concurrently, in this example, the borohydride-containing material loses its stability during the reaction of metal and alkaline due to the consumption of the hydroxide. As NaOH is consumed in the above reaction, borohydride loses its stability and produces hydrogen gas by a hydrolysis reaction:

NaBH₄+2H₂O=NaBO₂+4H₂↑

The hydrolysis reaction is accelerated by the heat produced by the metal's reaction with hydroxide. As we noted above, the hydrolysis reaction of sodium borohydride may be accelerated by using the transition metal-based catalysts listed there and by adding other de-stabilizers such as acidic materials.

### EXAMPLE

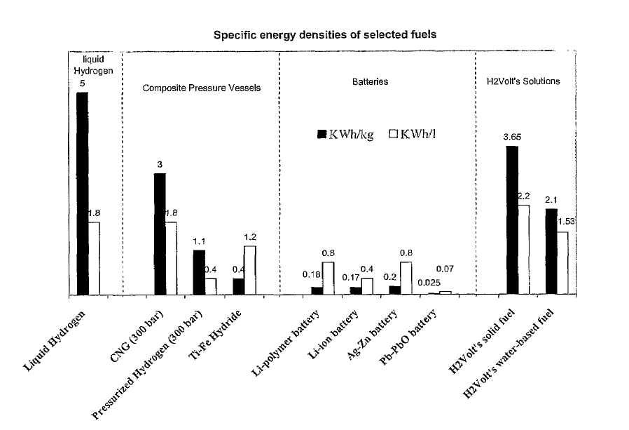

In our process, hydrogen is produced in two steps. For example, using 1 mol of aluminum (27 grams), 1 mol of sodium borohydride (37.8 gram), and 1 mol of sodium hydroxide (40 gram) will produce 11 grams of hydrogen gas (or 123 liters of hydrogen gas (STP)), which equals to 11.2 wt % hydrogen capacity. If such hydrogen is used in a fuel cell, it produces 233 watt-hours of electricity (assuming a single fuel cell gives 0.6 volt). FIG. 1 is the comparison of specific energy density of several of today's most used energy sources with the technology.

Clearly, if the exemplified composition is changed within the parameters of shown here, the hydrogen capacity or energy density also changes. For example, when the concentration of sodium borohydride is changed to 36 weight percent, the energy density of the metal based hydrogen source changes from 0.95 to 3.65 kWh/kg (or from 0.62 to 2.1 kWh/kg—when water is also considered) The composition can be changed according to applications, byproduct requirement, and cost etc.

The composition, devices, and procedures have been described in connection with a specific example, it is not intended that such description limit the scope of the claims in any way, but on the contrary, the description is intended to cover such alternatives, modifications, and equivalents as may be included within the spirit and scope of the invention as defined by the appended claims.

1. A composition for the production of hydrogen comprising:
a) one or more hydrogen-producing hydride components that react with water to produce hydrogen,
b) one or more hydrogen-producing metal components that react with a chemical base to produce hydrogen, and
c) the chemical base that:
i) stabilizes the one or more hydrogen-producing hydride components against reaction with water to produce hydrogen, and
ii) reacts with the one or more hydrogen-producing metal components in an aqueous reaction media to produce hydrogen.

2. The composition of claim 1 where the one or more hydrogen-producing hydride components comprise metal, semi-metal, or ammonium hydrides.

3. The composition of claim 2 where the one or more metal, semi-metal, or ammonium hydrides are selected from the group consisting of alkali metal and alkaline earth metal hydrides.

4. The composition of claim 2 where the one or more metal or semi-metal hydrides are selected from the group consisting of metal borohydrides.

5. The composition of claim 1 where the one or more hydrogen-producing hydride components comprise one or more metal, semi-metal, or ammonium hydrides, having the general chemical formula MBH₄ where:
M is one or more of an alkali metal (lithium, sodium, potassium, rubidium, and cesium) and an alkaline earth metal (beryllium, magnesium, calcium, strontium, and barium) or ammonium or organic group.
B is selected from boron, aluminum, and gallium, and
H is hydrogen.

6. The composition of claim 1 where the one or more hydrogen-producing hydride components comprise NaBH₄, LiBH₄, KBH₄, Mg(BH₄)₂, Ca(BH₄)₂, NH₄BH₄, (CH₃)₄NH₄BH₄, NaAlH₄, LiAlH₄, KAlH₄, NaGaH₄, LiGaH₄, KGaH₄, and their mixtures.

7. The composition of claim 1 where the one or more hydrogen-producing hydride components comprise sodium borohydride (NaBH₄), lithium borohydride (LiBH₄), potassium borohydride (KBH₄), ammonium borohydride (NH₄BH₄), tetramethyl ammonium borohydride ((CH₃)₄NH₄BH₄), quaternary borohydrides, and their mixtures.

8. The composition of claim 1 where the one or more hydrogen-producing hydride components comprises sodium borohydride (NaBH₄).

9. The composition of claim 1 where the one or more hydrogen-producing metal components comprise pure metals, mixed metals, or alloys.

10. The composition of claim 9 where the one or more hydrogen-producing metal components comprise aluminum, magnesium, zinc, lithium, sodium, potassium, rubidium, or their mixtures.

11. The composition of claim 9 where the one or more hydrogen-producing metal components comprise aluminum, magnesium, zinc, or their mixtures.

12. The composition of claim 9 where the one or more hydrogen-producing metal components comprise aluminum.

13. The composition of claim 1 where:
A) the hydrogen-generating hydrides and chemical base components are admixed, and the hydrogen-generating metal components are isolated from the hydrogen-generating hydride and chemical base components; or
B) the hydrogen-generating hydrides, chemical base components, and the hydrogen-generating metal components are admixed, or
C) the hydrogen-generating hydrides, chemical base components, and the hydrogen-generating metal components are each isolated from one another.

14. The composition of claim 1 further comprising a catalyst configured to catalyze the production of hydrogen from hydrogen-generating hydrides.

15. The composition of claim 14 wherein the catalyst comprises one or more transition metals, transition metal borides, and alloys and mixtures of these materials.

16. The composition of claim 1 further comprising water.

17. The composition of claim 1 further comprising gaseous hydrogen.

18. A method for the production of hydrogen comprising:
a) providing the composition of claim 1,
b) dissolving the chemical base to destabilize the one or more hydrogen-producing hydride components against reaction with water to produce hydrogen, and produce an alkaline solution,
c) contacting the alkaline solution with the one or more hydrogen-producing metal components to produce hydrogen,
d) contacting the one or more hydrogen-producing hydride components with water to produce hydrogen.
